(19) United States
(12) Patent Application Publication
(10) Pub. No.: US 2012/0176768 A1
(43) Pub. Date: Jul. 12, 2012

(54) LED Light Tube

(75) Inventors: Kun-Hua WU, Hsinchu County (TW); Chih-Hao LIN, Taipei City (TW); Po-Chang CHEN, Tainan City (TW); Cheng-Wei HUNG, Chu-Nan Mao-Li County (TW); Yan-Liang LIN, New Taipei City (TW); Chi-Huang CHUANG, Taoyuan County (TW)

(73) Assignee: WELLYPOWER OPTRONICS CORPORATION, Hsinchu County (TW)

(21) Appl. No.: 13/155,399

(22) Filed: Jun. 8, 2011

(30) Foreign Application Priority Data
Jan. 7, 2011 (TW) 100100691

(51) Int. Cl. F21V 9/16

(52) U.S. Cl. 362/84

(57) ABSTRACT

An LED (Light-Emitting Diode) light tube includes a transparent tube, a phosphor layer and a base board. The phosphor layer is coated on a surface of the transparent tube, wherein a thickness of the phosphor layer is 10-100 μm. The base board is arranged inside the transparent tube for carrying a plurality of LEDs (Light-Emitting Diodes), wherein the length between the base board and the top of the transparent tube is H, and the distance between every two adjacent LEDs is P, and H/P is not smaller than 0.134 and H is 9.5-38 mm.

### RELATED APPLICATIONS

The application claims priority to Taiwan Application Serial Number 100100691, filed Jan. 7, 2011, which is herein incorporated by reference.

### BACKGROUND

1. Technical Field

The present disclosure relates to a light tube. More particularly, the present disclosure relates to an LED (Light-Emitting Diode) light tube.

2. Description of Related Art

An LED is a semiconductor element. In the beginning, the LED is often used as an indicator, a bulletin board and so on; with the appearance of a white LED, the LED is also used for illumination. The LED is a new type of light source in the 21^{St} century, which has the advantages of high efficiency, long operation life, unbreakability with which the other traditional light sources cannot compete. While a forward voltage is applied, the LED can emit a monochromatic and discontinuous light, which is an electroluminescent effect. By changing the chemical compositions of the semiconductor materials forming an LED, the LED can be enabled to emit near ultraviolet (UV) light, visible light or infrared light.

However, fluorescent tube specification has been used for many years; in order to meet the needs of peripheral industries of fluorescent tube, an LED light tube is presented to the market. Although the LED light tube has inherited the advantages of the LED for illumination, yet if the LED is simply disposed into a common transparent tube, the problems such as glare or uneven illumination will be caused because of the LED itself is a point light source.

### SUMMARY

Hence, an aspect of the present invention is to an LED light tube which provides uniform illumination with no bright spots without sacrificing intensity of illumination.

According to one embodiment of the present invention, an LED light tube includes a transparent tube, a phosphor layer and a base board. The phosphor layer is coated on a surface of the transparent tube, wherein a thickness of the phosphor layer is 10-100 μm. The base board is arranged inside the transparent tube for carrying a plurality of LEDs (Light-Emitting Diodes), wherein the length between the base board and the top of the transparent tube is H, and the distance between every two adjacent LEDs is P, and H/P is not smaller than 0.134 and H is 9.5-38 mm.

### BRIEF DESCRIPTION OF THE DRAWINGS

FIG. 1 is a schematic diagram showing the structure of an LED light tube according to one embodiment of the present invention;

FIG. 2 is a schematic cross-sectional view showing the LED light tube of FIG. 1;

FIG. 3 is a schematic cross-sectional view showing the LED light tube of FIG. 1;

FIG. 4 is an enlarged fragmentary view of FIG. 2;

FIG. 5 is a functional block diagram showing the working principle of the LED light tube of FIG. 1;

FIG. 6 is a diagram showing the relationship of light intensity/view angle of an LED shown in FIG. 1; and

FIG. 7 is a diagram showing the limit of emitting light angle of an LED shown in FIG. 6.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically depicted in order to simplify the drawings.

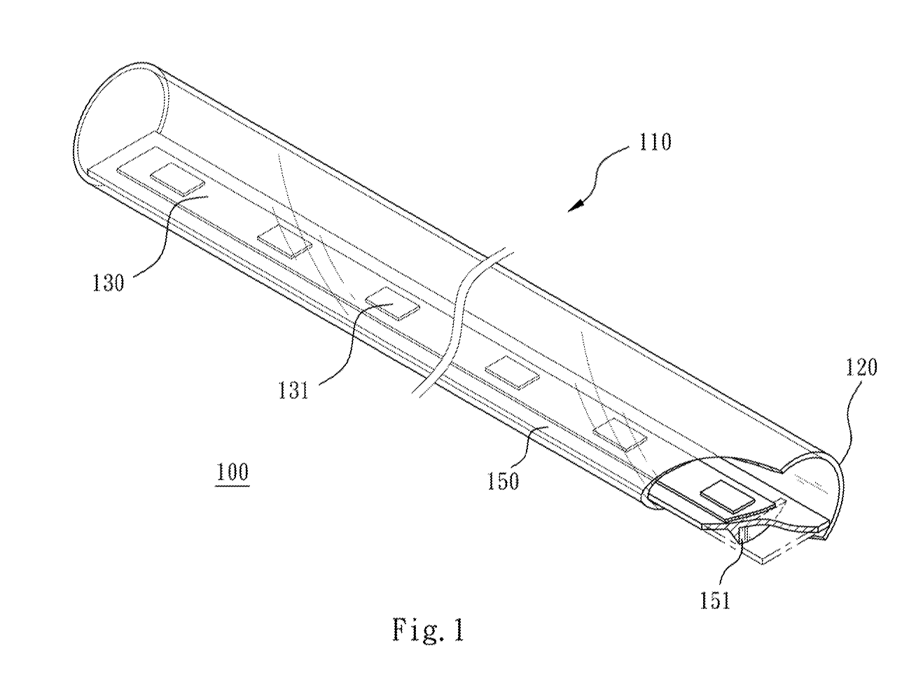

Referring to FIG. 1, FIG. 1 is a schematic diagram showing the structure of an LED light tube according to one embodiment of the present invention. As shown in FIG. 1, the LED light tube 100 includes a transparent tube 110, a phosphor layer 120 and a base board 130. The phosphor layer 120 is coated on a surface of the transparent tube 110, wherein a thickness of the phosphor layer 120 is 10-100 μm. The base board 130 is arranged inside the transparent tube 110 for carrying a plurality of LEDs 131. The LED light tube 100 provides a lighting system; for example, the LEDs 131 can emit blue light, and the phosphor layer 120 can be formed from a yellow fluorescent powder. The surface of the heat dissipation plate 150 is attached to the base board 130 for better heat dissipation of the LEDs 131. For instance, one side of the heat dissipation plate 150 that is coated with thermal grease can be attached to the base board 130, and on the other side of the heat dissipation plate 150, a heat dissipation body 151, such as a heat dissipation fin, can be designed to increase the heat dissipation surface.

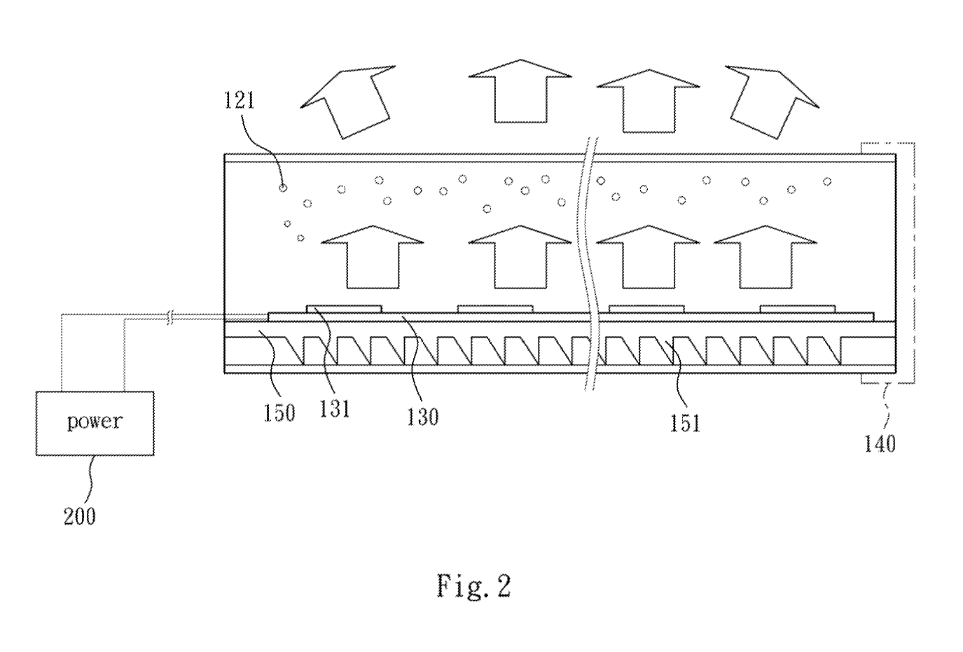

Referring to FIG. 2, FIG. 2 is a schematic cross-sectional view showing the LED light tube of FIG. 1. A power 200 is depicted in FIG. 2 for convenient interpretation, and the power 200 is electrically connected to the base plate 130 to supply power to the LED 131s. The transparent tube 110 can be a glass tube, and its length is 200-1500 mm; for example, the main composition of the glass tube is silica and can be mixed with another element such as potassium, sodium, boron, etc. On the other hand, the transparent tube 110 further includes two covers 140 which are disposed respectively at both ends of the transparent tube 110 for sealing the base plate 130 within the transparent tube 110. Furthermore, in another embodiment, the space within the transparent tube 110 sealed by the two covers 140 can be vacuumed or filled with non-reactive gas such as argon, neon, for blocking moisture, oxygen and other gases that will harm the product within the tube, thus achieving moisture-proof purpose.

On the application of the phosphor, a particle diameter of a phosphor particle 121 is 1-40 μm that is smaller than the thickness of the phosphor layer 120; in particular, the diameter of the phosphor particle 121 in the phosphor layer 120 can be further controlled to be within 5-20 μm. For example, the phosphor layer 120 of 10 μm in thickness can be matched with the phosphor particle 121 of 5 μm in diameter. Further, an excitation wavelength of the phosphor layer 120 is 300-500 nm, and an emission wavelength of the phosphor layer 120 is 400-700 nm, and the wavelength of the LED is 300-700 nm.

In a working process, the phosphor layer 120 is coated on the surface of the transparent tube 110 under room temperature using water or solvent. For example, a water-coating process is performed under room temperature to prepare the LED light tube 100, which has the advantages of easy processing and rapid fabrication. Moreover, the light generated by the LED 131 is emitted after being reflected several times in the transparent tube 110, and thus has excellent uniformity and higher intensity of illumination than a common fluorescent light. On the other hand, one side of the base plate 130 carries the LED 131, and the other side thereof may be attached to the heat dissipation plate 150 for removing heat, thereby preventing thermal light attenuation.

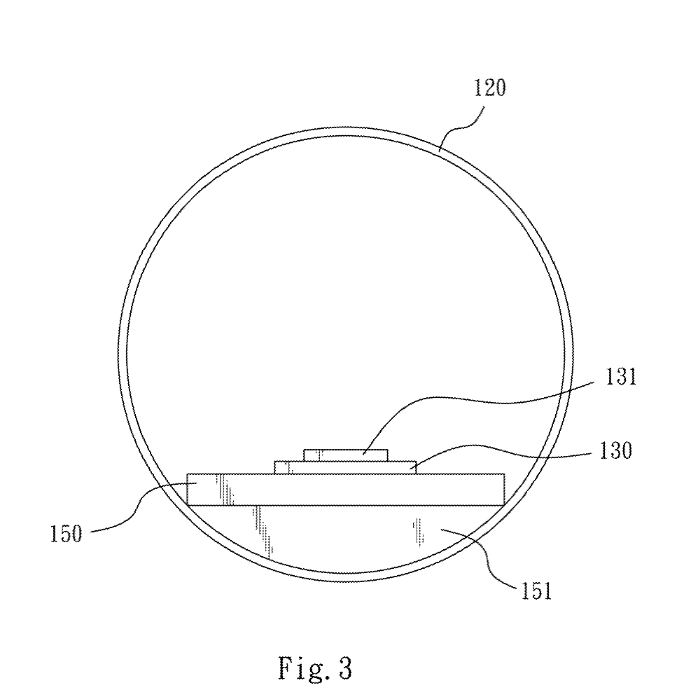

Referring to FIG. 3, FIG. 3 is a schematic cross-sectional view showing the LED light tube of FIG. 1. As shown in FIG. 3, the base plate 130 can be placed on a heat dissipation plate 150; overall speaking, the heat dissipation plate 150, the base plate 130 and even LED 131 are all arranged on one side of the transparent tube 110, so that the distance between the LED 131 and the light-emitting direction of the transparent tube 110 can be directly considered as the diameter of the transparent tube 110. The heat dissipation plate 150 can be made of a light metal such as aluminum fins or a heat dissipation pad; it is worth noting that if the heat dissipation plate 150 is made of aluminum fins, the heat dissipation plate 150 will be slightly larger than the base plate 130; but if heat dissipation pad is used as the heat dissipation plate 150, the heat dissipation plate 150 can be as large as base plate 130.

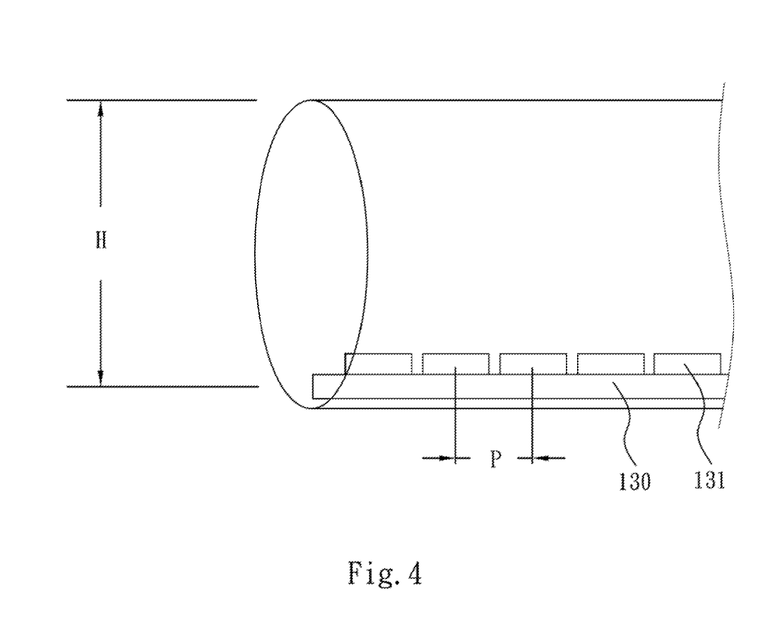

Referring to FIG. 4, FIG. 4 is an enlarged fragmentary view of FIG. 2. As shown in FIG. 4, the length between the LED 131 and the transparent tube 110 is H, and the distance between every two adjacent LEDs 131 is P; H/P is not smaller than 0.134, and H is 9.5-38 mm. In other words, H is equal to the diameter of the transparent tube 110 itself, and the transparent tube 110 can use the standard of T5, T8 or T12, and so on. The H/P ratio of 0.134 is found by the present invention after precise calculation as follows.

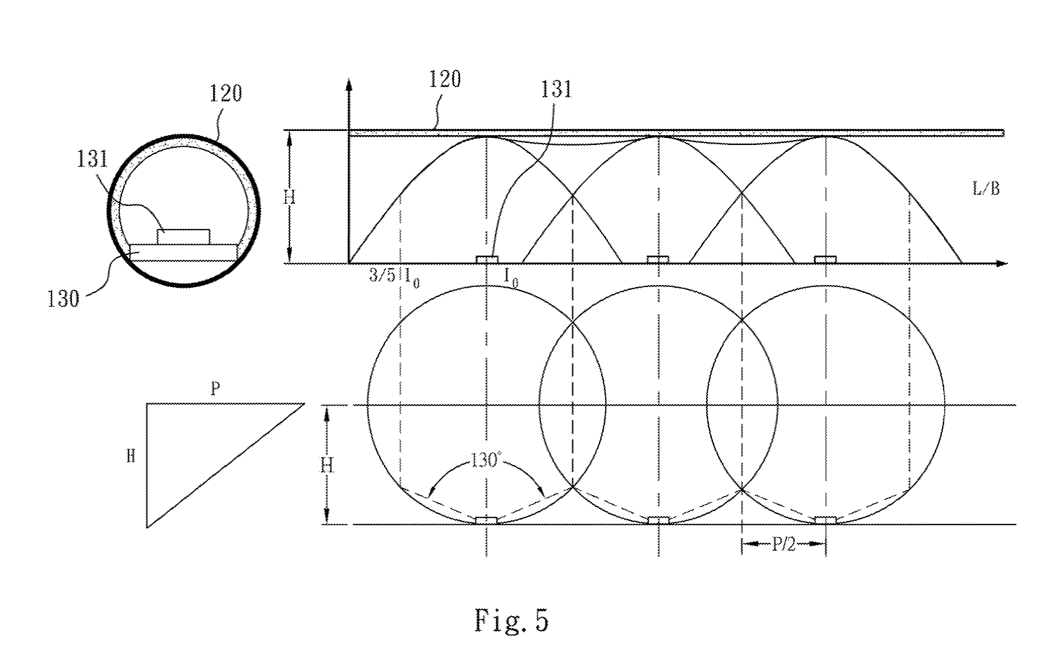

Referring to FIG. 5, FIG. 5 is a functional block diagram showing the working principle of the LED light tube of FIG. 1. As shown in FIG. 5, the light-emitting angle of the LED 131 can be 110-140 degrees, for example, the maximum light-emitting angle of the LEDs is designed as 130 degrees; wherein the light-emitting angle is considered as the boundary at which illumination is decreased by 50%; of course, the light-emitting angle also can be designed as 180 degrees. Through the actual simulation of FIG. 5, the beam intensity I₀ provided by each LED 131 will decay with distance, and when only 60% of the beam intensity I₀ remains, i.e. 3/5I₀, the difference between I₀ and 3/5I₀ will be perceived and identified by human's eyes. However, in the design within this embodiment, every two LEDs 131 of 30% I₀ will overlap with each other to reinforce illumination. After the blue light of the LED 131 reaches the phosphor layer 120 of the surface of the transparent tube 110 after superposition, the bright spots can be removed to make the light evenly.

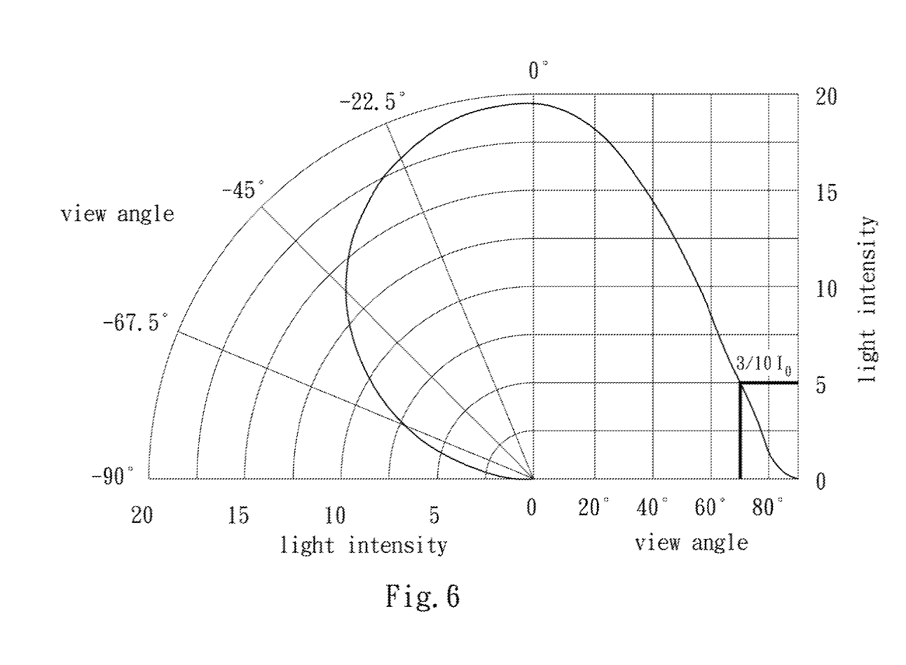

However, in consideration of the discrimination capability of human's eyes, that the H/P ratio must equal or higher than 0.134 is found by the present invention after precise calculation. Referring to FIG. 6, FIG. 6 is a diagram showing the relationship of light intensity/view angle of an LED shown in FIG. 1. It can be known from FIG. 6 that the light intensity of one single LED 131 varies with the angle of divergence, and the 3/10I₀ light intensity falls approximately at the visual angle of 75 degrees. In other words, if an intersection of two adjacent LEDs 131 falls at their light intensities of 3/10I₀, under the mutual reinforcements, the lower limit of the human visual recognition, that is 60% of the total illumination I₀, can be produced.

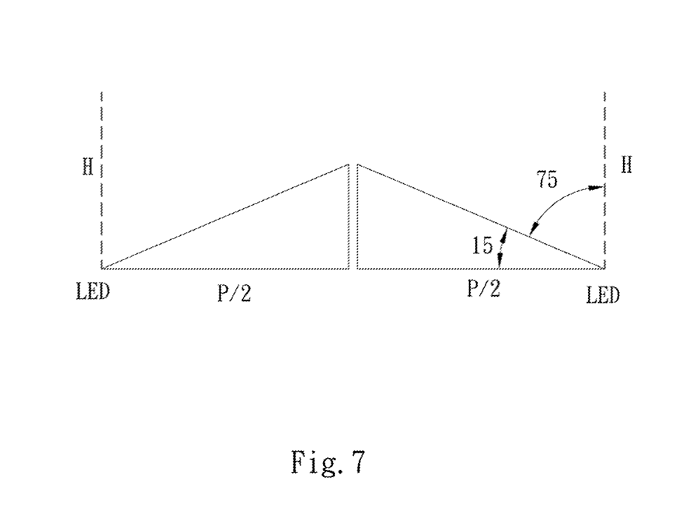

Referring to FIG. 7, FIG. 7 is a diagram showing the limit of emitting light angle of an LED shown in FIG. 6. When the light-emitting angle is 130 degrees, in order to enable the light intensity provided by the LED 131 to reach evenly to the surface of the transparent tube 110, which is the light intersection of two adjacent LEDs 131, each providing the light intensity of 3/10I₀ for making to the light intensity 3/5I₀ after mutual reinforcement, thus reaching the recognition limit of human's eyes, the distance P between every two adjacent LEDs, and the length H between the LED 131 and the top of the transparent tube 110, must satisfy the following equations:

$$\frac{H}{P / 2} = tan 15 ° = 0.268 \\ = > \frac{H}{P} = 0.134$$

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. An LED (Light-Emitting Diode) light tube, comprising:
a transparent tube;
a phosphor layer coated on a surface of the transparent tube, wherein a thickness of the phosphor layer is 10-100 μm; and
a base board arranged inside the transparent tube for carrying a plurality of LEDs (Light-Emitting Diodes), wherein the length between the base board and the top of the transparent tube is H, and the distance between every two adjacent LEDs is P, and H/P is not smaller than 0.134 and H is 9.5-38 mm.

2. The LED light tube of claim 1, wherein the transparent tube is a glass tube.

3. The LED light tube of claim 1, wherein a diameter of a phosphor particle in the phosphor layer is 1-40 μm, and the diameter of the phosphor particle is smaller than the thickness of the phosphor layer.

4. The LED light tube of claim 3, wherein the diameter of the phosphor particle in the phosphor layer is 5-20 μm.

5. The LED light tube of claim 1, wherein an excitation wavelength of the phosphor layer is 300-500 nm, and an emission wavelength of the phosphor layer is 400-700 nm.

6. The LED light tube of claim 1, wherein the wavelength of the LEDs is 300-700 nm.

7. The LED light tube of claim 1, wherein the maximum light-emitting angle of the LEDs is 110-140 degrees.

8. The LED light tube of claim 1, wherein the maximum light-emitting angle of the LEDs is 110-180 degrees.

9. The LED light tube of claim 1, wherein the length of the transparent tube is 200-1500 mm.

10. The LED light tube of claim 1, further comprising:
two covers arranged respectively at both ends of the transparent tube for sealing the transparent tube.

11. The LED light tube of claim 10, wherein the transparent tube and the covers form a sealed space filled with non-active gas.
